(19) United States
(12) Patent Application Publication
(10) Pub. No.: US 2008/0074808 A1
(43) Pub. Date: Mar. 27, 2008

(54) Magnetoresistive element, manufacturing method thereof, and magnetic storage device utilizing the same magnetoresistive element

(75) Inventors: Hideyuki Akimoto, Kawasaki (JP); Naoki Mukoyama, Kawasaki (JP)

Correspondence Address: GREER, BURNS & CRAIN, LTD., Suite 2500, 300 South Wacker Drive, Chicago, IL, 60606, US

(73) Assignee: FUJITSU LIMITED

(21) Appl. No.: 11/710,736

(22) Filed: Feb. 26, 2007

(30) Foreign Application Priority Data
Sep. 27, 2006 (JP) 2006-263418

(51) Int. Cl. G11B 5/33

(52) U.S. Cl. 360/324.12

(57) ABSTRACT

A magnetoresistive element 11 is formed with inclusion of a free layer 12, a pinned layer 13, an antiferromagnetic layer 14 for pinning the pinned layer 13, an intermediate layer 15 provided between the free layer 12 and the pinned layer 13, and a ferromagnetic layer 16 for applying a longitudinal bias magnetic field to the free layer. After initial magnetization, characteristic evaluation is conducted for the magnetoresistive element 11. Intensity of longitudinal bias field is adjusted by magnetizing again in a direction different from that of the initial magnetization, if required, on the basis of the evaluation result.

The present invention relates to magneto-resistive elements, and more specifically to a structure of a ferromagnetic layer for adjusting a bias magnetic field to a free layer in a magneto-resistive element.

### BACKGROUND OF THE INVENTION

A structure of a magnetic head 10 used in a magnetic disk drive is shown in FIG. 1. The magnetic head 10 includes a read head 4 and a write head 9. The read head 4 has a magnetoresistive element 2 for reproduction (GMR element, TMR element) held between a lower shield layer 1 and an upper shield layer 3. The write head 9 has a lower magnetic pole 5 and an upper magnetic pole 7 arranged to provide a write gap 6, and a coil 8 for recording.

A conventional magnetoresistive element used in a magnetic head is shown in FIG. 2. FIG. 2 is a side view of the magnetoresistive element when the surface thereof opposed to a medium is viewed from the side of the medium. An element 11 for detecting a magnetic field includes a free magnetic layer 12 formed of a soft magnetic material, a pinned magnetic layer 13, an anti-ferromagnetic layer 14 for pinning the pinned magnetic layer 13, and an intermediate layer 15 provided between the free layer 12 and the pinned layer 13. Magnetization of the pinned layer 13 is pinned in the direction of magnetization of the anti-ferromagnetic layer 14. The free layer 12 changes the angle of magnetization in response to the magnetic field of the medium. The intermediate layer 15 is formed of a conductive material such as Cu. Moreover, ferromagnetic layers 16 for applying a longitudinal bias field are located on both sides of the element 11 via an underlayer 17 of Cr or the like.

Intrinsically, magnetization of the free layer 12 at the end part of the element is difficult in the core width direction, because it is subjected to a self-demagnetizing field, and the free magnetic layer 12 responds hysteretically to the magnetic field of the medium without turning to the core width direction, resulting in Barkhausen noise. Here, the direction indicated by an arrow mark “a” in FIG. 2 is called the core width direction.

Accordingly, the ferromagnetic layers 16 are placed on both sides of the element 11 and the longitudinal bias field is applied to the free layer 12. Thereby, the free layer 12 can be rotated in the vertical direction in response to the magnetic field of the medium in order to suppress the Barkhausen noise. The magnetization 18 of this ferromagnetic layer 16 is oriented in the core width direction through application of an external magnetic field 19, as shown in FIG. 3(a). For example, in conventional technology, when a magneto-resistive element is used in a magnetic head, after film formation of the read head 4 and write head 9 on a wafer and before cutting of the wafer, the magnetization 18a of the ferromagnetic layer 16 is established in the core width direction “a”.

A longitudinal bias field applying layer can be magnetized with inclination from the core width direction. However, the technology relates to an MR element including a soft adjustment layer (SAL). Barkhausen noise is suppressed by magnetizing with an inclination from the core width direction to the longitudinal bias field applying layer in order to optimize the direction of magnetization of the soft adjustment layer and the MR layer, considering the soft adjustment layer field.

In the case of the magnetic head 10 using a magnetoresistive element, ten to twenty thousands of magnetic heads are manufactured, for example, on a 5-inch size wafer. However, at the central area and the circumference thereof, it is difficult to manufacture the magnetoresistive elements of the same shape because an incident angle in ion milling is different in such regions.

The intensity of the longitudinal bias field applied to the free layer 12 from the ferromagnetic layer 16 depends on the shape, material, film thickness, and film forming condition of the ferromagnetic layer 16. In the related art, it has been impossible to change the intensity of the longitudinal bias field after formation of the ferromagnetic layer 16.

Moreover, the ferromagnetic layer 16 suppresses on one hand the Barkhausen noise generated by unstable activity of the magnetic domain of the free layer 12 due to the longitudinal bias field, but also lowers output. That is, when the longitudinal bias field is excessively intensive, the output is reduced more than is desirable, and when the longitudinal bias field is excessively weak, the Barkhausen noise is generated. As explained above, output becomes low or unstable depending on fluctuation of the longitudinal bias field. This is a problem in manufacturing magnetic heads.

Moreover, when specifications of a magneto-resistive element are changed, the ferromagnetic layer must typically be re-designed to generate the optimum longitudinal bias field. This requirement is a problem because the development period for magnetic heads has become shorter in recent years.

### SUMMARY OF THE INVENTION

In keeping with one aspect of this invention, a magnetoresistive element includes a free layer, a pinned layer, an anti-ferromagnetic layer for pinning magnetization of the pinned layer, an intermediate layer provided between the free layer and the pinned layer, and a ferromagnetic layer for applying a longitudinal bias field to the free layer.

A longitudinal bias field of the free layer is adjusted from the ferromagnetic layer by magnetizing, in the direction of a first external magnetic field, the ferromagnetic layer by applying the first external magnetic field; after evaluating the characteristics of the magnetoresistive element, magnetizing, in the direction of a second external magnetic field, the ferromagnetic layer by applying a second external magnetic field in a direction different from the direction of the first external magnetic field.

When the ferromagnetic layer is magnetized with an inclination from the core width direction, the intensity of the longitudinal bias field to the free layer becomes equal to about the cosine element of the intensity in the conventional ferromagnetic layer. Accordingly, the longitudinal bias field to the free magnetic field from the ferromagnetic layer can be adjusted to improve the characteristics of the magnetoresistive element in the following way. First, the ferromagnetic layer of the magnetoresistive element is evaluated with an evaluating apparatus. Then, the ferromagnetic layer of the magnetoresistive element is magnetized again in a different direction based on the result of the evaluation explained above.

The magnetoresistive element of the present invention can be used to read a magnetic disk in a magnetic storage device. The disk drive also includes a flexible suspension which is coupled to the magnetic head, an actuator which fixes the end part of the suspension and moves rotationally by itself, and a detecting circuit device which is electrically connected with the magnetic head via an insulated conductive lead wire on the suspension and the actuator, to detect an electrical signal read by the magnetic head from the magnetic disk.

With the magnetoresistive element, manufacturing method of the same, and magnetic storage device using the same magnetoresistive element of the present invention, the longitudinal bias field can be optimized after formation of the ferromagnetic layer. Shortage in output and instability resulting from fluctuation in the characteristics of the ferromagnetic layer can be improved, and manufacturing yield of the magnetoresistive element can also be improved. Moreover, a certain margin can be given to design of the ferromagnetic layer and thereby development time of the magnetoresistive element can be shortened. In addition, a stable magnetic storage device can be provided by utilizing the magneto-resistive element of the present invention.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a cross-sectional view showing a structure of a conventional magnetic head.

FIG. 2 is a side view showing a conventional magnetoresistive element.

FIGS. 3(a) and 3(b) are explanatory diagrams of the magnetizing conditions of the free magnetic layer and ferromagnetic layer in the first embodiment of the present invention, viewed from the direction vertical to the film surface.

FIGS. 4(a)-4(c) are explanatory diagrams of the magnetizing conditions of the free magnetic layer and ferromagnetic layer in a second embodiment of the present invention, viewed from the direction vertical to the film surface.

FIG. 5 is a schematic structural diagram of a magnetic head evaluating apparatus.

FIG. 6 is a plan view of a magnetic storage device using the magnetoresistive element of the present invention.

FIG. 7 is an enlarged perspective view of a suspension using the magnetoresistive element of the present invention.

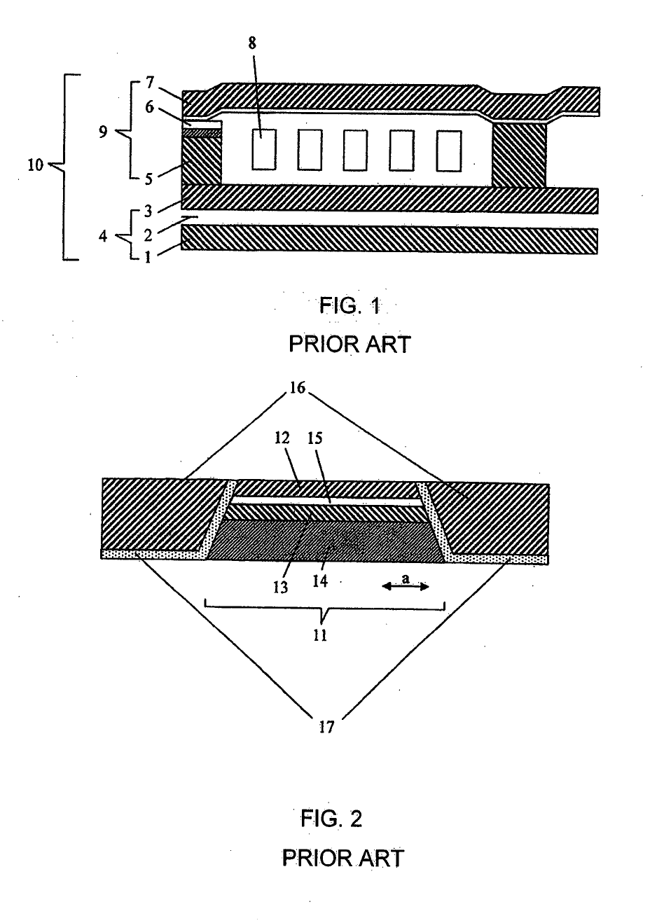

### DETAILED DESCRIPTION

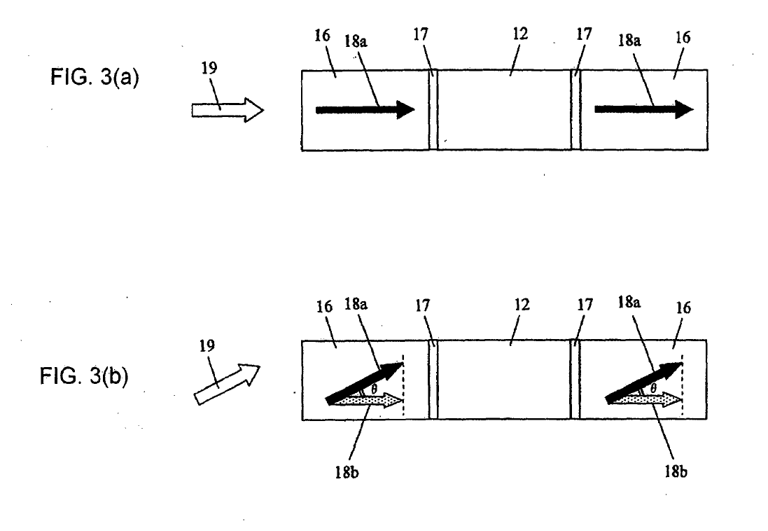

FIGS. 3(a) and 3(b) show the first embodiment of the manufacturing method of a magnetoresistive element of the present invention, in which the condition of magnetization 18a of a free layer 12 and a ferromagnetic layer 16 are viewed from the direction perpendicular to the film surface. Here, a pinned layer, an intermediate layer, an anti-ferromagnetic layer, electrodes, and a cap layer are not illustrated.

Referring briefly to FIG. 2, the magnetoresistive element includes, for example, a free layer 12 formed of NiFe of 4 nm thickness, a pinned layer 13 formed of CoFe alloy of 2 nm thickness, an anti-ferromagnetic layer 14 formed of PdPtMn of 15 nm thickness for pinning magnetization of the pinned layer 13, an intermediate layer 15 formed of Cu of 2 nm thickness provided between the free layer 12 and the pinned layer 13, and a ferromagnetic layer 16 formed of CoCrPt of 15 nm thickness on an underlayer 17 formed of Cr of 1.5 nm thickness. The ferromagnetic layer 16 is provided for applying a longitudinal bias field to the free layer 12.

It is also possible to form the ferromagnetic layer 16 with CoPt or the like, the free layer 12 with CoFe alloy or the like, the intermediate layer 15 with an insulating material such as Al₂O₃ and MgO, and the anti-ferromagnetic layer 14 with IrMn, NiO, FeMn or the like. In addition, it is possible to form the pinned layer 13 in the double-layer structure of CoFe/Ru/CoFe or the like using an intermediate material of Ru or the like. In some cases, an underlayer of Ta or the like may be provided to the antiferromagnetic layer 14 with a cap layer of Ta or the like applied to the free layer 12. In addition, these magnetoresistive elements may also be laminated in the inverse sequence.

Next, the manufacturing method of the magnetoresistive element will be explained below. First, before evaluation of the magnetoresistive element with an evaluation apparatus, the magnetization 18a of the ferromagnetic layer 16 is initially magnetized by applying an external magnetic field 19 in the core width direction, as shown in FIG. 3(a). It is theoretically enough for disposition of magnetism when an applied external magnetic field is equal to or higher than a coercive force of the ferromagnetic layer. However, when a magnetoresistive element is used in a magnetic head, upper and lower magnetic shields are provided, so the magnetic field must be strong enough to saturate the shield layers.

In this embodiment, the external magnetic field 19 can be set to 3000 Oe. The processes explained above are identical to the related art. With the magnetization explained above, a longitudinal bias field is applied to the free magnetic layer 12 in the magnetization direction 18a of the ferromagnetic layer 16. Thereafter, ideally, magnetization of the free magnetic layer 12 is not easily rotated by the magnetic field of a medium, and Barkhausen noise can be controlled.

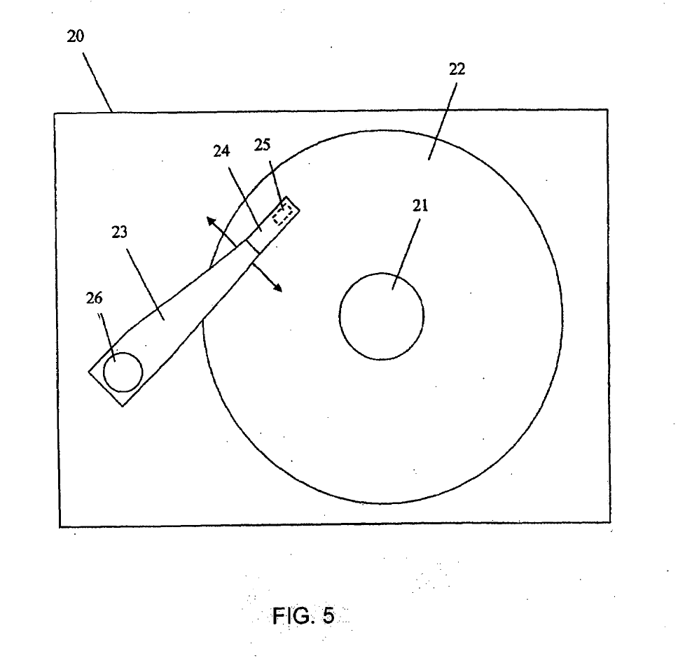

Next, characteristic evaluation of the magnetoresistive element is conducted using an evaluation apparatus. FIG. 5 is a schematic structural diagram of a magnetic head evaluating apparatus. Magnetic head evaluating apparatus 20 includes a spindle motor 21, a magnetic disk 22, and a head actuator 23. The magnetic disk 22 is fixed to the spindle motor 21. When the spindle motor 21 rotates in the higher rotating velocity of 3000 to 12000 rpm, the magnetic disk 22 also rotates at the same velocity. Moreover, a suspension 24 coupled with a slider 25 for mounting a magnetic head 10 can be secured to a head actuator 23 and the head actuator 23 is rotationally coupled to a pivot 26. Accordingly, when the head actuator 23 rotates around the pivot 26, the magnetic head 10 is positioned on the magnetic disk 22 in a generally radial direction. Moreover, the magnetic head 10 floats on the magnetic disk 22 due to the flow of air generated by the magnetic disk 22, and moves radially over the magnetic disk 22.

An evaluation pattern is recorded on the magnetic disk 22 with a write head 9 in the magnetic head 10. This evaluation pattern is read with a read head 4, and the characteristic evaluation of the magnetic head 10 can be realized, for example, from the amplitude and shape of the reproduced waveform. When the magnetoresistive element is used in the magnetic head as explained above, characteristic evaluation of the magnetoresistive element can be conducted using the magnetic head evaluating apparatus.

When the longitudinal bias field is applied excessively under the condition that the ferromagnetic layer 16 is too thick, response of the free layer 12 to the magnetic field of the medium is reduced, and reading output has sometimes been determined insufficient as a result of the characteristic evaluation of the magnetoresistive element.

Therefore, magnetization 18a of the ferromagnetic layer 16 of the magnetoresistive element is performed again by applying thereto an external magnetic field 19 of 3000 Oe in an inclined direction from the core width direction as shown in FIG. 3(b). The longitudinal bias field to the free layer 12 is equal to the magnetic field by the magnetization 18b of the cosine element of the magnetization 18a and is reduced from the initial condition thereof. Accordingly, reduced response of the free layer 12 to the magnetic field of the medium increases and thereby low reading output can be eliminated. In this manner, the intensity of this longitudinal bias field can be adjusted depending on the angle of magnetization.

Here, since the magnetization 18a of the ferromagnetic layer 16 is oriented in an inclined direction from the core width direction, both end portions in the core width direction of the free layer are influenced by the magnetic field in the inclined direction. However, the central area of the free layer is not influenced by the magnetic field in the inclined direction. Therefore, linearity of the magnetoresistive element is not influenced.

Accordingly, the Barkhausen noise can be controlled and stability can also be assured by first setting a large longitudinal bias field in the design stage. Moreover, the longitudinal bias field can be optimized, and yield of the magnetoresistive element can be improved by magnetizing again at a different angle for the magnetoresistive elements having low reading output. In this embodiment, magnetization 18a of the ferromagnetic layer 16 is inclined in the direction away from the opposing surface of the medium (up in FIG. 3 (b)), but a similar effect can also be attained by inclining magnetization in the direction facing the opposing surface of medium (down in FIG. 3(b)). This is also true in the second embodiment.

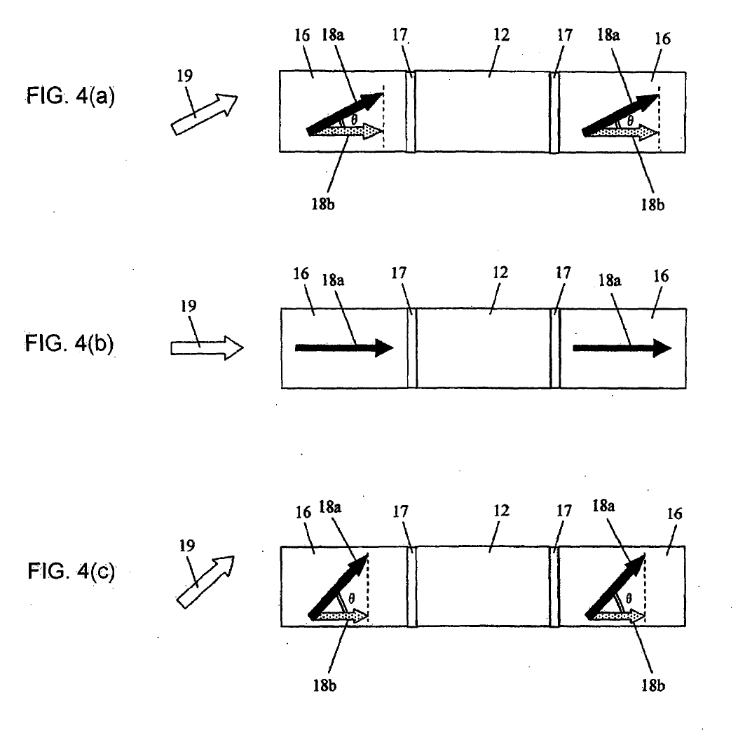

FIGS. 4(a)-4(c) show the second embodiment of the manufacturing method of magnetoresistive element of the present invention. FIGS. 4(a)-4(c) are explanatory diagrams of the magnetizing conditions of the free magnetic layer and the ferromagnetic layer viewed from the direction vertical to the film surface. The pinned layer, intermediate layer, anti-ferromagnetic layer, electrodes, and cap layer are not illustrated.

First, before evaluation of the magnetoresistive element by the evaluating apparatus, the ferromagnetic layer 16 is magnetized initially in the direction 18a by applying an external magnetic field 19 of 3000 Oe in a direction inclined from the core width direction, as shown in FIG. 4(a). This ferromagnetic layer is designed to provide the optimum longitudinal bias field under the condition of FIG. 4(a).

Next, characteristic evaluation of the magnetoresistive element is conducted using the evaluating apparatus 20. The longitudinal bias field is designed to produce the optimum value in the condition of FIG. 4(a), but not all magnetoresistive elements are applied with the optimum longitudinal bias field because of fluctuations in the shape and thickness of the ferromagnetic layer. Therefore, as a result of the evaluation, if the magnetoresistive element generates Barkhausen noise, the magnetization 18a of the ferromagnetic layer 16 is established again by applying the external magnetic field of 3000 Oe in the core width direction, as shown in FIG. 4(b), in order to control the Barkhausen noise by increasing the longitudinal bias field. On the other hand, for the magnetoresistive element having low reading output, the magnetization 18a of the ferromagnetic layer 16 is established again by applying the external magnetic field of 3000 Oe in the direction having an increased inclination angle, as shown in FIG. 4(c), in order to obtain the required reproduction output by reducing the longitudinal bias field.

As explained above, the Barkhausen noise of the magnetoresistive element can be controlled, or reading output thereof can be increased, and manufacturing yield thereof can also be improved by magnetizing the ferromagnetic layer again in a direction different from the direction of the magnetization using the evaluating apparatus 20. Moreover, it is also possible, by conducting the characteristic evaluation of the magnetoresistive element using the evaluating apparatus, that the magnetoresistive element can be subjected as many times as required to the magnetization in different angles.

In this embodiment, the longitudinal bias field is adjusted through repeated depositions of magnetism in the core width direction. However, for optimization of adjustment, magnetization is sometimes repeated in the direction of an acute angle for the core width direction more than the initial angle, depending on the intensity of the longitudinal bias field.

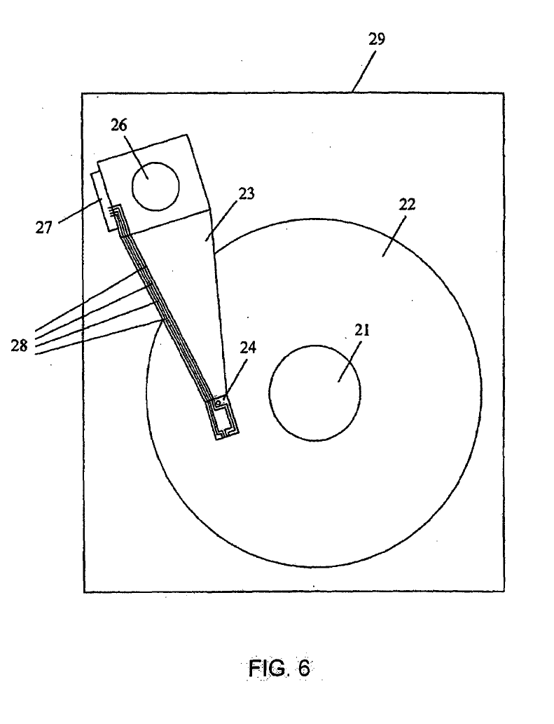

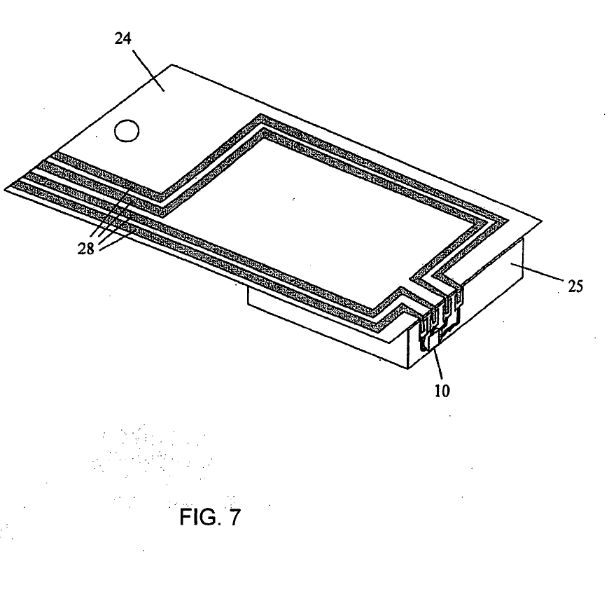

FIG. 6 is a plan view of a magnetic storage device using the magnetoresistive element of the present invention. The magnetic disk 22 includes magnetic information and is rotated at high velocity by the spindle motor 21. The actuator arm 23 is provided with the suspension 24 formed of flexible stainless steel. Moreover, the actuator arm 23 is fixed to a housing 29 to freely rotate around the pivot 26, and moves almost in the radial direction of the magnetic disk 22. Accordingly, the slider 25, which will be explained later, moves across the magnetic disk 22 and information is written on predetermined tracks.

At the side surface of the actuator arm 23, a detecting circuit device 27 for detecting write/read signals is provided. The detecting circuit device 27 can detect changes in the resistance value of the magnetoresistive element to recover information from the medium by applying a sense (detection) current to the magnetoresistive element in the magnetic head 10 and then measuring changes in the voltage of the magnetoresistive element caused by the magnetism in the medium.

FIG. 7 is an enlarged perspective view of the suspension 24 in this embodiment. The slider 25 is attached to the suspension 24 at the lower part thereof to form a head suspension assembly. When the magnetic disk 22 rotates at high velocity, air flows into a gap between the slider 25 and the magnetic disk 22 and the slider 25 floats due to the air pressure generated by disk rotation. The magnetic head 10 is electrically connected to the detecting circuit device 27 via the insulated conductive lead wires 28 on the suspension 24 and actuator arm 23.

The magnetoresistive element, manufacturing method thereof, and magnetic storage device using the magnetoresistive element of the present invention can also be applied in common to the magnetoresistive element, manufacturing method thereof, and magnetic storage device using the same magnetoresistive element comprising the layer (free magnetic layer) which freely changes the direction of magnetization in accordance with an external magnetic field of the spin valve type element and tunnel resistance effect type element or the like.

The magnetoresistive element and the manufacturing method thereof of the present invention can be used not only for magnetic heads for reading a magnetic field of a medium, but also in magnetic devices such as MRAM or the like. Moreover, the magnetic head using the magnetoresistive element of the present invention may be used as the magnetoresistive element provided in a read head not only of the so-called horizontal magnetic head but also of the vertical magnetic head.

While the principles of the invention have been described above in connection with specific apparatus and applications, it is to be understood that this description is made only by way of example and not as a limitation on the scope of the invention.

What is claimed is:

1. A magnetoresistive element comprising
a free magnetic layer,
a pinned layer,
an anti-ferromagnetic layer for pinning magnetization of said pinned layer,
an intermediate layer provided between said free layer and said pinned layer, and
a ferromagnetic layer for applying a longitudinal bias field to said free layer, said ferromagnetic layer having a core width,
wherein said ferromagnetic layer is magnetized at least in part by a magnetic field inclined with respect to the core width direction.

2. A magnetic storage device, comprising
a magnetic disk,
a magnetic head having a magnetoresistive element for reading recorded information from said magnetic disk, said magnetic element having
a free magnetic layer,
a pinned layer,
an anti-ferromagnetic layer for pinning magnetization of said pinned layer,
an intermediate layer provided between said free layer and said pinned layer, and
a ferromagnetic layer for applying a longitudinal bias field to said free layer, said ferromagnetic layer having core width,
wherein said ferromagnetic layer is magnetized at least in part by a magnetic field inclined with respect to the core width direction,
a flexible suspension which is coupled to said magnetic head,
an actuator which fixes the end part of said suspension and moves rotationally, and
a detecting circuit device which is electrically connected with said magnetoresistive element via an insulated conductive lead wire on said suspension and said actuator to detect an electrical signal read by said magnetoresistive element from said magnetic disk.

3. A method of manufacturing a magnetoresistive element comprising a free magnetic layer, a pinned layer, an antiferromagnetic layer for pinning magnetization of said pinned layer, a non-magnetic layer provided between said free magnetic layer and said pinned magnetic layer, and a ferromagnetic layer for applying a bias magnetic field to said free magnetic layer, comprising the steps of
magnetizing, in the direction of a first external magnetic field, said ferromagnetic layer by applying said first external magnetic field,
evaluating characteristics of said magnetoresistive element, and
magnetizing, in the direction of a second external magnetic field, said ferromagnetic layer by applying said second external magnetic field in a direction different from the direction of said first external magnetic field.
